(19) United States
(12) Patent Application Publication
(10) Pub. No.: US 2016/0126674 A1
(43) Pub. Date: May 5, 2016

(54) ELECTRICAL CONNECTOR

(71) Applicant: FOXCONN INTERCONNECT TECHNOLOGY LIMITED, Grand Cayman (KY)

(72) Inventor: ALBERT HARVEY TERHUNE, IV, Chandler, AZ (US)

(21) Appl. No.: 14/529,109

(22) Filed: Oct. 30, 2014

(51) Int. Cl. H01R 13/641; H01R 43/00; H01R 13/621

(52) U.S. Cl. CPC H01R 13/641; H01R 13/621; H01R 43/00

(57) ABSTRACT

An electrical connector (100) for mounting on a printed circuit board (PCB) (6) and has an insulating housing (1), a plurality of contacts (12) received in the insulating housing (1), a load plate (3) covering on the insulating housing (1) and having a tongue portion (32) and an indicating member (2) located under the tongue portion (32) of the load plate (3), the indicating member (2) has a dome portion (23) protruding toward the tongue portion (32) of the load plate (3), in use, when the load plate (3) is pressed downwardly, the tongue portion (32) of the load plate (3) presses the dome portion (23) downwardly to make a click sound.

### BACKGROUND OF THE INVENTION

1. Field of the Invention

The present invention relates generally to an electrical connector, and more particularly to an electrical connector with an indicating member to indicate a degree of a load plate being screwed onto a printed circuit board (PCB) and then preventing overstress thereby.

2. Description of Related Art

Normally, a Central Processing Unit (CPU) is usually assembled in a socket connector, and electrically connects to a print circuit board (PCB). The socket connector comprises an insulating housing with a plurality of contacts received therein, a metallic cover covering on the insulating housing and a screw assembled to the metallic cover. The CPU is assembled into the socket connector when the cover is at an open position. Thereafter, rotate the cover to a closed position and then tight the screw at a position where the cover exerts a pressure on the CPU to make sure that the CPU stays in the socket securely. However, when tight the screw, there is no any cue to tell the operator the screw has been tighted to its correct position. If the screw does not achieve its correct position, the load plate can not exert a normal force on the CPU, which can not ensure the connection between the contacts of the socket connector and the CPU. While if the screw is over-screwed, the force exerted by the load plate will damage the contacts.

U.S. Pat. No. 7,753,706 issued to Liu on Jul. 13, 2010 disclosed an electrical connector has an indicating member to give the operator a cue that the screw is screwed to its correct position. The indicating member is an elastic piece located between the tongue portion of the load plate and the PCB. The elastic piece has a flexible arm and a hook portion. The flexible arm can be pressed to deform and have elasticity. The top of the screwing element has a channel. When the screwing element is screwed to a locking position, the hook portion will jump in the channel so as to indicate the locking position. The structure of the elastic piece is complex due to having a hook portion and the load plate must set a fastening hole to permit the hook portion going through.

Hence, it is desirable to provide an improved electrical connector to overcome the aforementioned disadvantages.

### SUMMARY OF THE INVENTION

Accordingly, an object of the present invention is to provide an electrical connector with an indicating member to indicate that a load plate has been screwed onto a Printed Circuit Board (PCB) and then preventing overstress thereby.

According to one aspect of the present invention, an electrical connector for mounting on a printed circuit board (PCB) and comprises an insulating housing, a plurality of contacts received in the insulating housing, a load plate covering on the insulating housing and having a tongue portion and an indicating member located under the tongue portion of the load plate, the indicating member has a dome portion protruding toward the tongue portion of the load plate, in use, when the load plate is pressed downwardly, the tongue portion of the load plate presses the dome portion downwardly to make a click sound.

Other objects, advantages and novel features of the invention will become more apparent from the following detailed description when taken in conjunction with the accompanying drawings, in which:

### BRIEF DESCRIPTION OF THE DRAWINGS

FIG. 1 is an exploded view of an electrical connector according to the present invention;

FIG. 2 is an isometric view of the indicating member as shown in FIG. 1;

FIG. 3 is an assembled view of the electrical connector as shown in FIG. 1; and

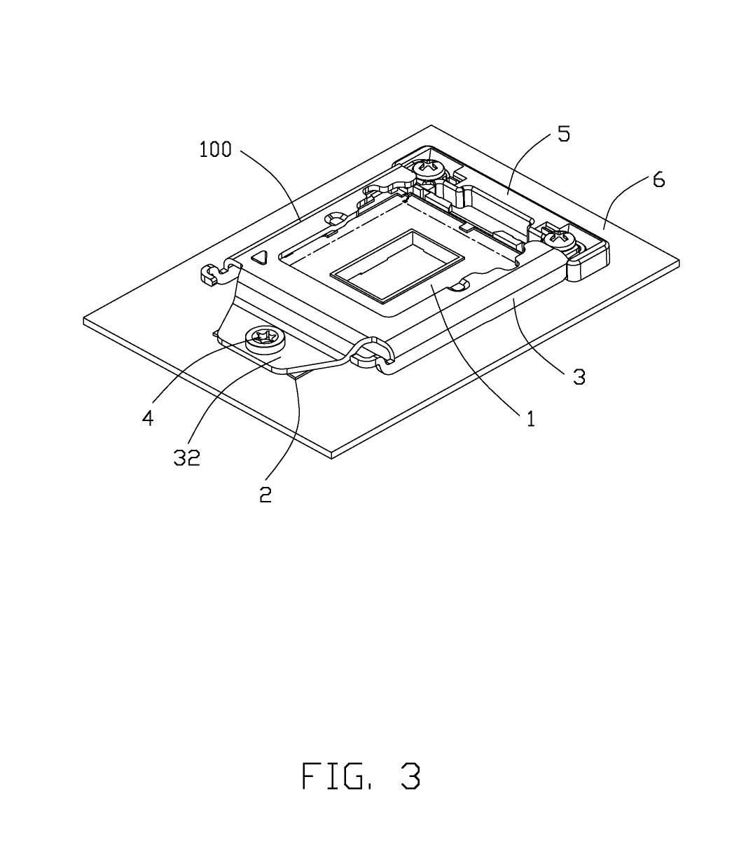

FIG. 4 is front side view of the electrical connector as shown in FIG. 3.

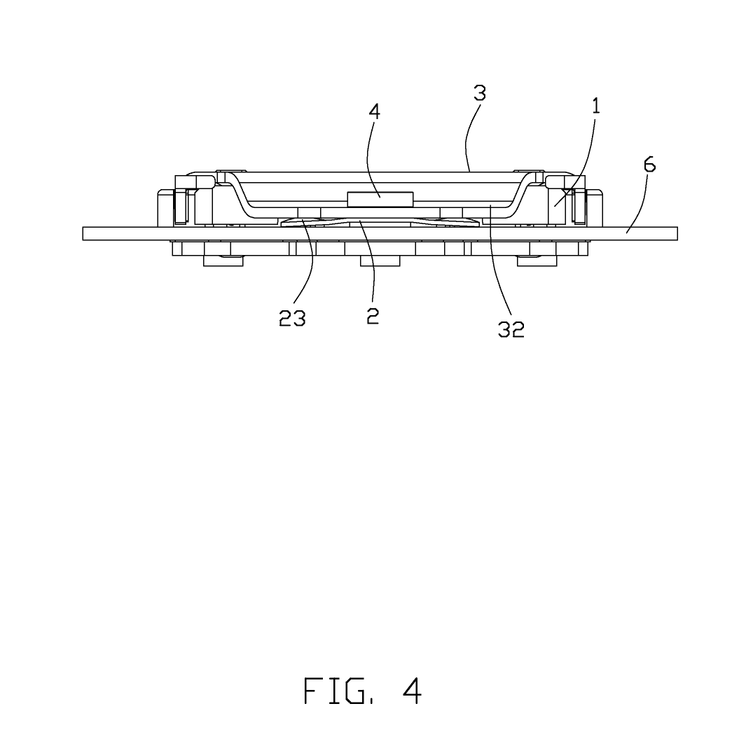

### DETAILED DESCRIPTION OF THE INVENTION

Reference will now be made to the drawings to describe the present invention in detail.

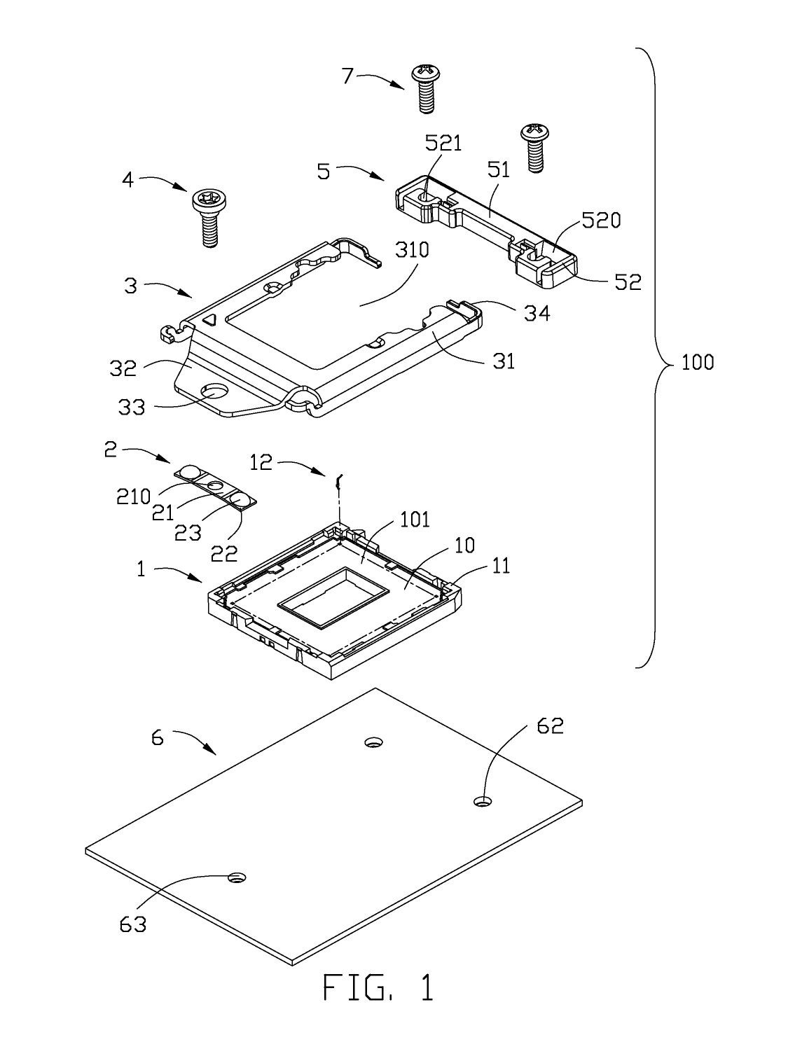

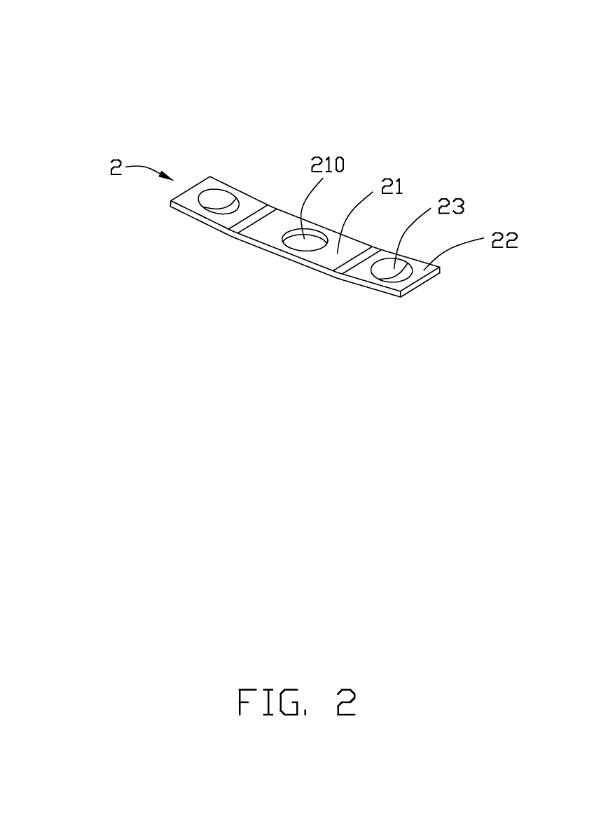

Referring to FIGS. 1-2, an electrical connector 100 of the present invention is used for connecting a central processing unit (CPU, not shown) with a printed circuit board (PCB) 6. The electrical connector 100 comprises an insulating housing 1 mounted on the PCB 6, a plurality of contacts 12 received in the insulating housing 1, a fixing member 5 assembled on the PCB 6, a load plate 3 pivotally assembled to the fixing member 5 and covering on the insulating housing 1, an indicating member 2 located between the load plate 3 and the PCB 6, a pair of fastening members 7 and a screwing member 4 assembled to the PCB 6. The pair of fastening members 7 are assembled to the fixing member 5 and the PCB 6 to fix the fixing member 5 to the PCB 6.

The insulating housing 1 defines a bottom wall 10 and four sidewalls 11 extending upwardly from the bottom wall 10. The bottom wall 10 and the four sidewalls 11 form a space 101 for receiving the CPU. The contacts 12 are received in the bottom wall 10 of the insulating housing for electrically connecting the CPU with the PCB 6.

The PCB 6 defines a first aperture 63 at a front end thereof and a pair of second apertures 62 at a back end thereof. The first aperture 63 and the second apertures 62 are respectively located at two opposite sides of the insulating housing 1.

The fixing member 5 is configured to a substantially U-shape and includes a pair of recesses 520 on two ends thereof and a pair of through holes 521 communicated with the pair of recesses 520 respectively. The pair of recesses 520 is right-angled, recessed from a top surface of the fixing member 5. The fastening members 7 pass through the through holes 521 and the second apertures 62 of the PCB 1 in sequence to secure the fixing member 5 on the PCB 6.

The load plate 3 has a main portion 31 with a window 310 thereof, a tongue portion 32 extending from a front end of the main portion 31, and a pair of pivotal portions 34 extending from the opposite end of the main portion 31. The pair of pivotal portions 34 extends toward each other. The pivotal portions 34 are securely received in the pair of recesses 520 of the fixing member 5 and fixed to the fixing member 5 by the fastening members 7. The tongue portion 32 defines a fixing hole 33 to permit the screwing member 4 going through.

The indicating member 2 comprises a flat body portion 21 and a pair of bending portions 22 extending from opposite ends of the body portion 21. The body portion 21 defines a hole 210. Each of the bending portions 22 defines a dome portion 23 toward the tongue portion 32 of the load plate 3. The indicating member 2 can be pressed to deform and have elasticity. When the dome portions 23 of the indicating member 2 are pressed to a certain degree, they will make a click sound. When the load plate 3 is assembled to the PCB 6, the bending portions 22 of the indicating member 2 are supported by the PCB 6.

After the electrical connector 100 is assembled to the PCB 6, the insulating housing 1 is assembled to the PCB 6 through soldering the contacts 12 on the PCB 6, the fixing member 5 is assembled to the PCB 6 by the fastening members 7, the load plate 3 is pivotally assembled to the fixing member 5 by the fastening members 7, the screwing member 4 goes through the fixing hole 33 of the tongue portion 32 and the hole 210 of the indicating member 2 to secure the indicating member 2 on a bottom side of the load plate 3. At this stage, the dome portions 23 and the body portion 21 all contact with the tongue portion 32 of the load plate 3.

When assemble the CPU to the electrical connector 100, rotate the load plate 3 to an open position, put the CPU into the space 101 of the insulating housing 1, rotate the load plate 3 to a closed position, then rotate the screwing member 4 to make the load plate 3 press the CPU downwardly. During this process, the tongue portion 32 of the load plate 3 further press the dome portion 23 downwardly. When the screwing member 4 is screwed to a correct position, the dome portion 23 will collapse and make a click sound to cue the operator the screwing member 4 is screwed to a correct position, and that also means the dome portion 23 goes downwardly a certain height. When loose the screwing member 4, the dome portion 23 of the indicating member 2 will go back to its original shape. Understandably, it is also workable when the indicating member 2 is installed in an upside-down manner

While the preferred embodiments in accordance with the present invention has been shown and described, equivalent modifications and changes known to persons skilled in the art according to the spirit of the present invention are considered within the scope of the present invention as defined in the appended claims.

What is claimed is:

1. An electrical connector for mounting on a printed circuit board (PCB), comprising:
an insulating housing;
a plurality of contacts received in the insulating housing;
a load plate covering on the insulating housing and having a tongue portion; and
an indicating member located under the tongue portion of the load plate; wherein
the indicating member has a dome portion protruding toward the tongue portion of the load plate, and in use, when the load plate is pressed downwardly, the tongue portion of the load plate will press the dome portion downwardly to make a click sound to indicate the complete securement of the connector upon the PCB.

2. The electrical connector as claimed in claim 1, wherein the indicating member defines a body portion and a pair of bending portions at opposite ends of the body portion, the dome portion is formed on the bending portions.

3. The electrical connector as claimed in claim 2, wherein the dome portion and the body portion both contact with the tongue portion of the load plate simultaneously.

4. The electrical connector as claimed in claim 3, wherein when the load plate is assembled to the PCB, the bending portions of the indicating member are supported by the PCB.

5. The electrical connector as claimed in claim 4, wherein the tongue portion of the load plate defines a fixing hole, the body portion of the indicating member defines a hole corresponding to the fixing hole of the tongue portion.

6. The electrical connector as claimed in claim 5, wherein the electrical connector further has a screwing member going through the fixing hole of the tongue portion and the hole of the indicating member to position the indicating member under the tongue portion of the load plate.

7. The electrical connector as claimed in claim 1, wherein the electrical connector further has a fixing member, the load plate is pivotally assembled to the fixing member.

8. The electrical connector as claimed in claim 7, wherein the fixing member defines a pair of recesses and the load plate defines a pair of pivotal portions received in the pair of recesses respectively.

9. The electrical connector as claimed in claim 8, wherein the fixing member further has a pair of through holes, the electrical connector further includes a pair of fastening members going through the pair of through holes to fix the load plate on the fixing member.

10. A method of assembling an electrical connector for mounting on a printed circuit board (PCB), comprising steps of:
providing an insulating housing with a plurality of contacts received in the insulating housing;
providing a load plate covering on the insulating housing and having a tongue portion;
screwing a screwing member to assembled the tongue portion of the load plate upon the PCB; and
providing an indicating member associated with the load plate and located under the tongue portion of the load plate and upon the PCB; wherein
the indicating member includes a dome portion generating a click sound when experiencing deformation under a pressure due to downward movement of the load plate when the screw is tightened while resuming to an original form when the pressure is removed due to unscrewing the screwing member.

11. The method as claimed in claim 10, wherein said indicating member includes a body portion and a bending portion angled with the body portion, and said dome portion is located upon the bending portion.

12. The method as claimed in claim 11, wherein the dome portion and the body portion both contact with the tongue portion of the load plate simultaneously.

13. The method as claimed in claim 12, wherein when the load plate is assembled to the PCB, the bending portions of the indicating member are supported by the PCB.

14. The method as claimed in claim 11, wherein the tongue portion of the load plate defines a fixing hole, the body portion of the indicating member defines a hole corresponding to the fixing hole of the tongue portion, the screwing member goes through the fixing hole of the tongue portion and the hole of the indicating member to position the indicating member under the tongue portion of the load plate.

15. The method as claimed in claim 11, further providing a fixing member upon PCB, wherein the load plate is pivotally assembled to the fixing member.

16. An electrical connector assembly comprising:
a printed circuit board (PCB);
an insulative housing mounted upon the PCB and defining a receiving cavity in an upper face;
a plurality of contacts disposed in the housing with contacting sections exposed in the receiving cavity;
a load plate moveably located upon the housing to cover the housing;
an indicating member located between the load plate and the PCB with capability of deformation to generate a sound for indicating fastening between the load plate and the PCB; and
a screw associated with the load plate to secure the load plate to the PCB and resulting in said sound corresponding to deformation of the indicating member in a vertical direction.

17. The electrical connector assembly as claimed in claim 16, wherein said indicating member includes at least one dome portion generating said sound.

18. The electrical connector assembly as claimed in 17, wherein a bulged portion of said dome portion contacts the load plate.

19. The electrical connector assembly as claimed in claim 17, wherein said indicating member includes a body portion and a bending portion angled to the body portion, and the dome portion is located upon the bending portion.

20. The electrical connector assembly as claimed in claim 19, wherein said screw extends through the body portion.
